(19) United States
(12) Patent Application Publication
(10) Pub. No.: US 2005/0071198 A1
(43) Pub. Date: Mar. 31, 2005

(54) Available inpatient psychiatric bed locator and community resource need tracker

(76) Inventor: Michael P. Krupa, Concord, MA (US)

Correspondence Address: LACASSE & ASSOCIATES, LLC, 1725 DUKE STREET, SUITE 650, ALEXANDRIA, VA, 22314, US

(21) Appl. No.: 10/951,631

(22) Filed: Sep. 29, 2004

Related U.S. Application Data
(60) Provisional application No. 60/481,437, filed on Sep. 29, 2003.

(51) Int. Cl. G06F 17/60

(52) U.S. Cl. 705/2

(57) ABSTRACT

A network-based service whereby hospital Emergency Departments and other acute care, crisis service providers, and insurers may access an up-to-date database listing available inpatient mental health beds satisfying user-selected criteria.

### RELATED APPLICATIONS

The present application is related to and claims priority from the previously filed Provisional Patent Application Ser. No. 60/481,437, entitled “Available Inpatient Psychiatric Bed Locator and Community Resource Need Tracker” filed on Sep. 29, 2003, the disclosure of which is incorprated herein by reference in its entirety.

### BACKGROUND OF THE INVENTION

1. Field of Invention

The present invention relates generally to the field of organized health care. More specifically, the present invention is related to efficient identification and allocation of medical resources.

2. Discussion of Prior Art

Prior art attempts at efficiently placing patients in medical facilities have included a variety of deficiencies. First, emergency rooms as well as other professionals seeking inpatient resources for psychiatric patients encountered long time delays in locating services that could potentially serve their patients. These delays related to the business process of using telephones to find such services. These delays resulted both in poorer patient care and in higher-cost care without adding any benefits or value. Second, inpatient providers are often inefficient both in fielding such phone calls and in alerting potential utilizers of their services during those occasions when they have beds available. Third, inpatient providers also have no simple method to alert potential users that they either accept a new insurance or that they no longer accept a given insurance. Fourth, inpatient providers are unable to accurately track demand for inpatient services in their primary service area beyond data they receive through phone calls for their own services (e.g., they know nothing about why the phone doesn't ring.) Fifth, during times of system-wide higher census, patients are more likely to be hospitalized further away from their homes than necessary. Sixth, insurers and other interested parties have no way to determine the average distance between patient homes and available, as opposed to actual accessed services. Finally, no simple method of finding available beds bundles each of the potential solutions to the problems listed above and couples it with the capacity to generate road maps to a given inpatient service.

Specific solutions that have been attempted in the past for one or more aspects of these problems have included at least the following:

A. A fax-in process was created and abandoned in Massachusetts during the mid-1980's whereby hospitals would fax how many beds they had available as of some common time in the morning. Those searching for beds could then call a common number to request the names of hospitals in a given area with open beds. The problems with the above solution include at least the following:

1. Some hospitals were reluctant to reveal the number of open beds.

2. The data of having an open bed is not specific enough for the search task as it is blind to patient gender, age, insurance type, home zip code, primary diagnosis.

3. The method does not indicate or track data regarding service demand.

4. Having open beds is a status that can change rapidly and repeatedly throughout the day.

5. The scope of the business process is less encompassing of the invention described herein.

B. A telephonically accessed resource is available in the greater New York City area whereby participating hospitals can dial a dedicated phone number, and, using the keypad, enter information about their facility and the number of current open beds. Those seeking services may dial this same number and enter information through the key pad indicating certain information about a bed they are seeking. The caller then receives the names of hospitals that had such openings as of the last call-in period. The problems with the above solution include at least the following:

1. The data of having an open bed is not specific enough for the search task as it is blind to patient gender, age, insurance type, home zip code, primary diagnosis.

2. The method does not indicate or track data regarding service demand.

3. Having open beds is a status that can change rapidly and repeatedly throughout the day (This service is updated approximately 3 times per week).

4. The scope of the business process is less than the invention described herein.

C. A web-enabled service called MentalHealthAccess.com allows participating users to log on and conduct a search by service type, age category (e.g., child, adolescent, adult), gender, and diagnosis. The problems with the above solution include at least the following:

1. Some hospitals were reluctant to reveal the number of open beds (which this system posts as part of the results page).

2. The data of having an open bed is not specific enough for the search task as it is blind to exact age, insurance type, and home zip code of a given patient. However, it did include gender.

3. The method does not indicate or track data regarding service demand.

4. Having open beds is a status that can change rapidly and repeatedly throughout the day. This business process does not call for multiple daily updates.

5. The system does not have a means to calculate geographic distances between the home zip code of a given patient and the location of a given inpatient service.

6. The system does not have a means by which to rank-order the list of available inpatient beds by geographic proximity.

7. The system does not have the capacity to provide a map with driving directions to a given provider.

8. The scope of the business process is less than the invention described herein.

Whatever the precise merits, features and advantages of the above cited attempts at addressing these problems, none of them achieve or fulfills the purposes of the present invention.

### SUMMARY OF THE INVENTION

Accordingly, embodiments of the present invention relate to a service whereby hospital Emergency Departments (ED's) and other acute care, crisis service providers, and insurers may access an up-to-date database that lists available inpatient mental health beds satisfying user-selected criteria.

One aspect of the present invention relates to a method for a healthcare provider to locate a bed at another facility for a patient. In accordance with this aspect of the invention, a respective profile for a plurality of facilities is stored and made available for searching. Each profile include criteria related to an available bed at that facility. When a search request to locate an available bed is received, the respective profiles are searched based on the search request. It is worth noting that the search request includes a location of the patient. After the searching is complete, an identification of matching facilities, if any, from among the plurality of facilities, are displayed that are within a predetermined distance of the location of the patient. In accordance with further aspects of this invention, the matching facilities are ranked by their proximity to the residence of the patient.

Another aspect of the present invention relates to a method for a third-party to facilitate the identification of available beds within a geographical region. In accordance with this aspect, the third-party provides storage for a respective profile for each of a plurality of inpatient facilities, wherein each respective profile includes criteria related to an available bed at that inpatient facility. Also, the third-party permits a healthcare organization to search the respective profiles to locate, for a patient, an available bed matching a specified set of criteria. Once the search is complete, an identification of matching facilities, if any, that are within a predetermined distance of the patient is returned to the healthcare organization. The third party is able to generate revenue by charging the inpatient facilities for storing the profile information and charging the healthcare organization for searching the stored profiles.

Other aspects of the present invention will become apparent from the detailed description and claims that follow.

### BRIEF DESCRIPTION OF THE DRAWINGS

FIG. 1 illustrates an exemplary network configuration of a web site in accordance with the principles of the present invention.

FIG. 2 depicts a flowchart of an exemplary method for a bed provider to reveal availability of beds in accordance with the principles of the present invention.

FIG. 3 depicts a flowchart of an exemplary method for a medical subscriber to locate available beds in accordance with the principles of the present invention.

FIG. 4 depicts a flowchart of an exemplary method of operating the web site of FIG. 1.

FIGS. 5A-5N illustrate exemplary user interface screens for implementing the method of FIGS. 2-4.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. For example, the specific exemplary embodiments which are described below relate to psychiatric beds; however, systems and methods for allocating and locating other types of medical beds may also operate according to the principles of the present invention.

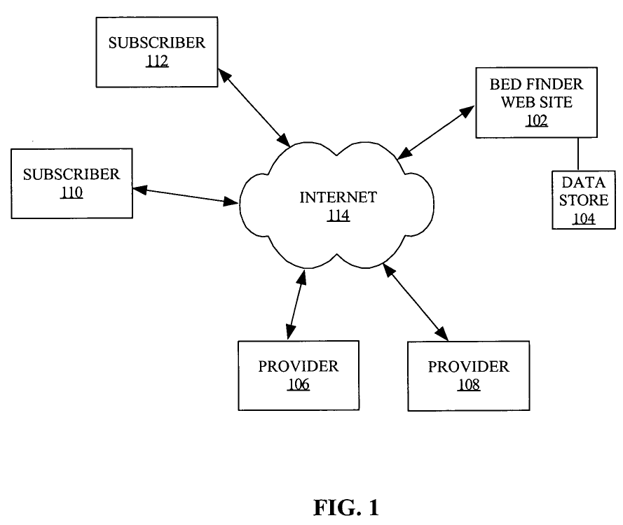

One exemplary embodiment of the present invention includes a web site that is coupled to the Internet. Various subscribers and providers communicate with the web site and utilize it to efficiently and effectively allocate available medical resources. Referring to FIG. 1, the web site 102 is coupled to the Internet 114. For the purposes of the invention, the web site 102 may represent practically any type of computer, computer system or other programmable electronic device, including a client computer, a server computer, a portable computer, a handheld computer, an embedded controller, etc. Moreover, the web site 102 may be implemented using one or more networked computers, e.g., in a cluster or other distributed computing system. The web site 102 will hereinafter also be referred to as a “computer”, although it should be appreciated the term 1/3pparatus may also include other suitable programmable electronic devices consistent with the invention.

Computer 102 operates under the control of an operating system, and executes or otherwise relies upon various computer software applications, components, programs, objects, modules, data structures, etc. Moreover, various applications, components, programs, objects, modules, etc. may also execute on one or more processors in another computer coupled to computer 102 via a network 114, e.g., in a distributed or client-server computing environment, whereby the processing required to implement the functions of a computer program may be allocated to multiple computers over a network. The computer 102 also includes mass storage devices 104 for storing data in a non-volatile manner.

In general, the routines executed to implement the embodiments of the invention, whether implemented as part of an operating system or a specific application, component, program, object, module or sequence of instructions, or even a subset thereof, will be referred to herein as “computer program code”, or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

In FIG. 1, the web site, or computer, 102 is available to different providers 106, 108 and subscribers 110, 112. A provider 106, 108 is a medical center or unit that provides beds to one or more patients. A subscriber 110, 112 is an entity that wants to locate a bed for a patient. For example, a hospital emergency room (E.R.) or a managed healthcare organization may be subscribers who frequently need to locate available beds outside their facilities for their patients.

For example, patients presenting to an E.R. in need of psychiatric or substance abuse services are first evaluated by nursing, physician and/or mental health professionals. In the past, the patients must then wait while a phone search for an available bed ensues. Presently, these searches are conducted by telephoning providers whose names, numbers, and data as to what patients they can accept is typically stored on a rolodex file. Searches conducted in this way can take anywhere from 15 minutes to several days with most typical searches lasting 1-4 hours.

In accordance with the present invention, however, the searching for available beds is provided in a timely fashion by the web site 102 using up-to-date availability information. In general, this web site 102 stores information about which providers 106, 108 have available beds matching various criteria; and, when a search is initiated by a subscriber 110, 112 for a bed, the web site can return information related to that search.

Typically, each inpatient psychiatric provider has a set of relatively fixed criteria that make the service potentially available to a given client. These fixed criteria include the AGES and GENDER served, the INSURANCE TYPES accepted, and occasional EXCLUSORY OR INCLUSORY SPECIALTY CLINICAL CRITERIA.

Age: Most services are divided into Child (4 years up through 15 years old), Adolescent (12 years through 19 years), Adult (16 or 21+) and Geriatric (60 or 65 and older).

Gender: Although most providers accept both Male and Female patients, some specialty programs accept only men or women.

Insurance: All providers participate in certain insurance programs and may not eligible to receive others. A patient may meet all clinical and age criteria for admission but carry an insurance that will not reimburse the hospital for care. Also, some providers do not accept uninsured patients while others may be obligated to do so.

Exclusory or inclusive specialty clinical criteria: Occasionally psychiatric services exclude patients with a history of fire-setting, sexual assault, severe physical assaultiveness, acute suicidality, use of a feed-tube, IV's, oxygen tanks and other medical conditions, or refusal to be voluntarily admitted. Occasionally, a hospital service may provide specialized care in the area of eating disorders, substance abuse, medical-psychiatric disorders, fire-setting or other areas.

In addition to those criteria described above, a provider may have conditions and/or criteria for admission that can vary daily or even hourly. The most obvious and most frequently occurring variable criteria is whether a provider is fully occupied and thus cannot admit any additional patients. In addition to being full, a provider may have only a female or only a male bed available as only one bed is empty in a double or triple room with males or females occupying the other bed(s). In such cases the gender of the patient will influence where a bed can be found at a given point in time.

Specialized programming such as dual diagnosis groups (substance abuse and psychiatric illness), eating disorders, trauma victims, and medical-psychiatric units may make the selection of a geographically more distant but specialized service preferable over another more proximate service. Embodiments of the present invention allow, but do not necessarily require, a provider to specify specialized treatment and permit search results to include information about such specialties.

Finally, being able to select from those providers with an open bed, the provider that is able to take the age and gender of a patient with their particular insurance, and is the most geographically accessible, is enormously valuable.

Embodiments of the present invention permit a subscriber 110, 112 to go on-line into the web site 102, log-in, and initiate a search for available beds by answering a series of questions. Upon entering this data, a list of those providers 106, 108 with available beds matching the criteria entered will be listed on the screen in order of geographic proximity to the patient's home. In certain embodiments, a subscriber may request directions to a given facility, wherein the directions may be available directly or through a link provided on the site. These directions may be from the subscriber's location or from the patient's residence. Also available, is the name, phone and/or beeper # of the intake clinician for that provider. Search results also include other user-selected information such as inclusion in a particular hospital network or specialty treatment programs.

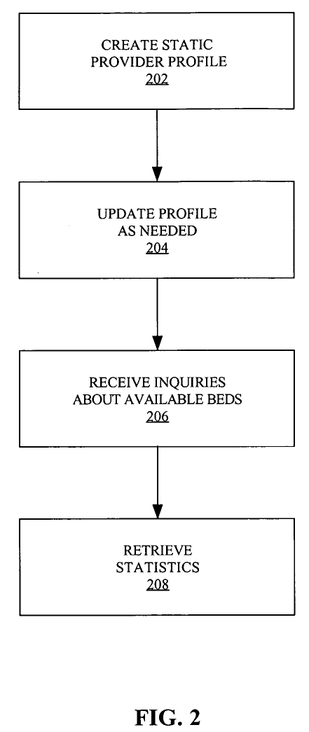

FIG. 2 depicts a flowchart of an exemplary method for a bed provider to make available information about the availability of beds in accordance with the principles of the present invention. In step 202, the provider logs into the web site to create a static profile of the types of patients for which it provides beds. The static profile will include information such as the identity of the provider, the location of the provider, the contact information for intake personnel, and other similar information. In addition, the static profile will identify the types of patients for which it has beds available. The criteria identified above such as age, gender, insurance type, exclusionary criteria, specialty areas, etc. can all be specified within the static profile.

However, as mentioned, the status of available beds at a provider may change on a daily or even hourly basis. Accordingly, a provider will occasionally need to change the static profile to reflect the beds that currently remain available at the facility. In step 204, therefore, the provider logs into the web site and updates the profile as needed.

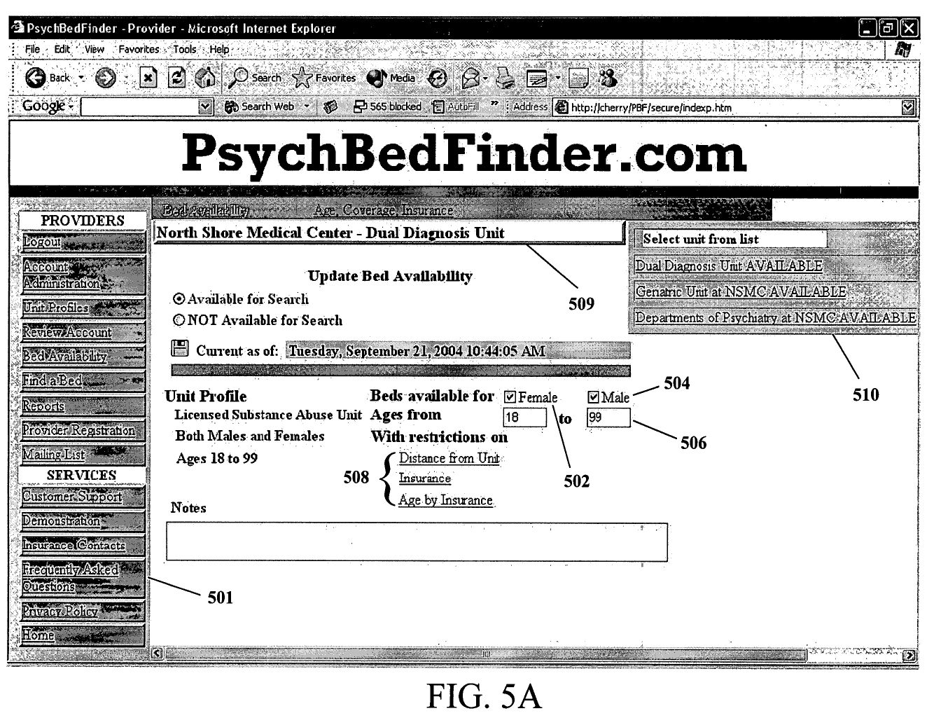

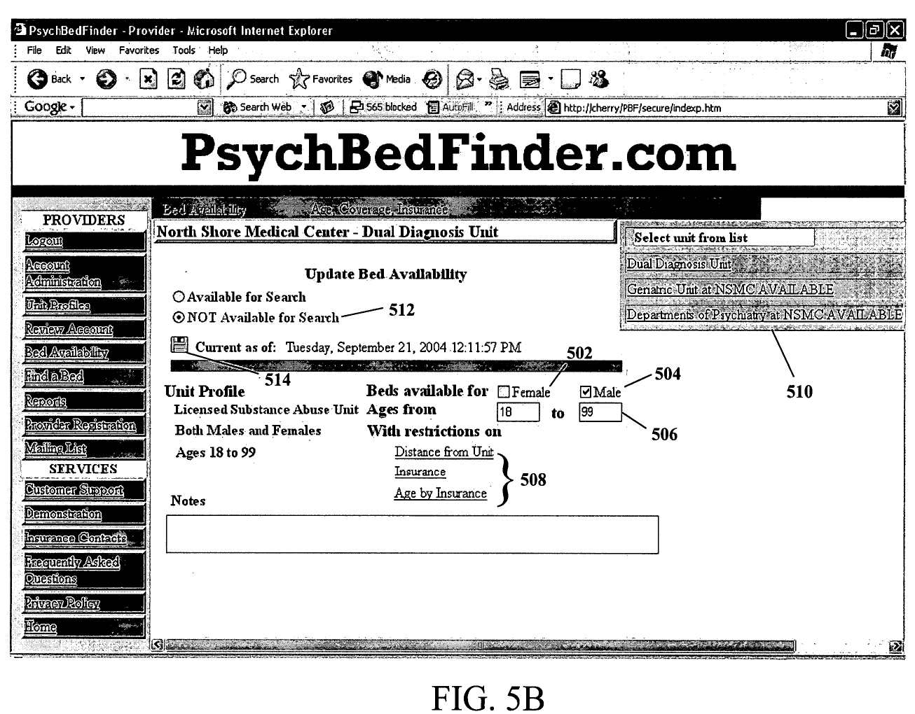

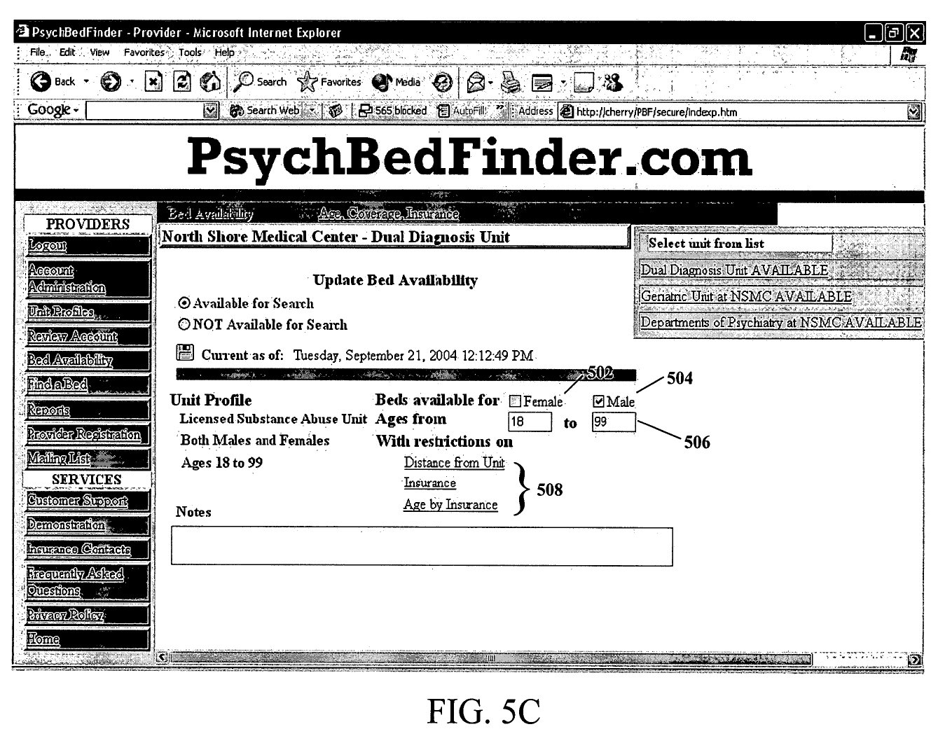

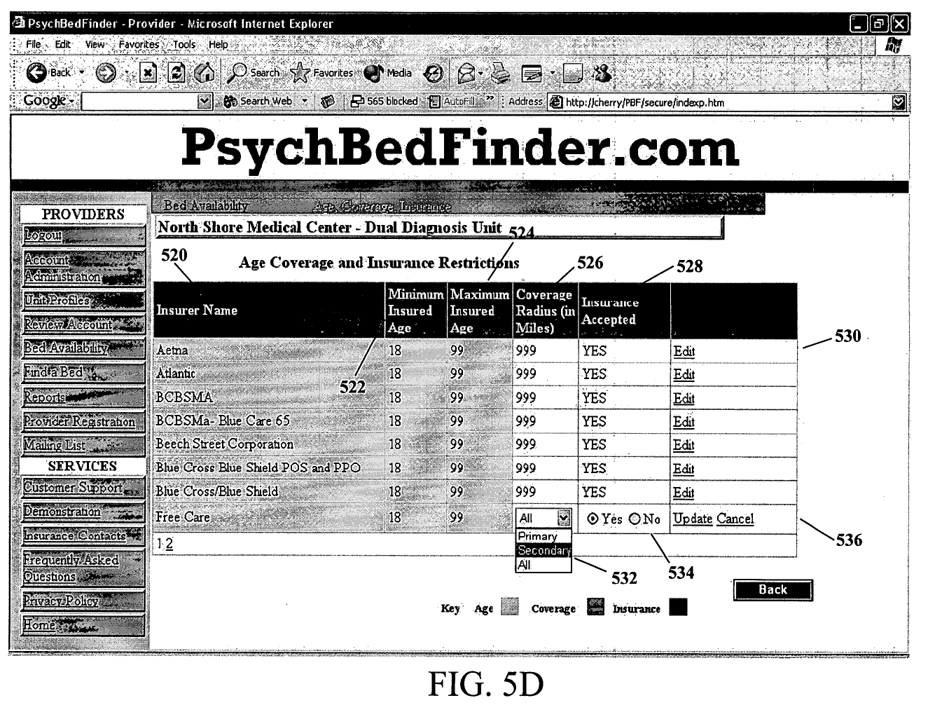

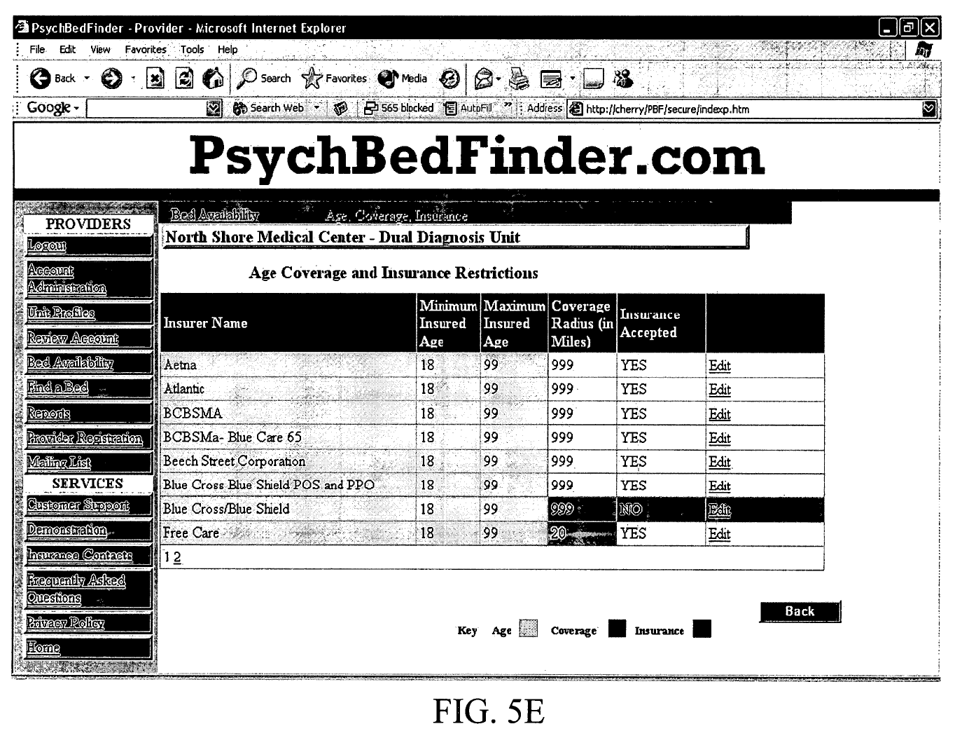

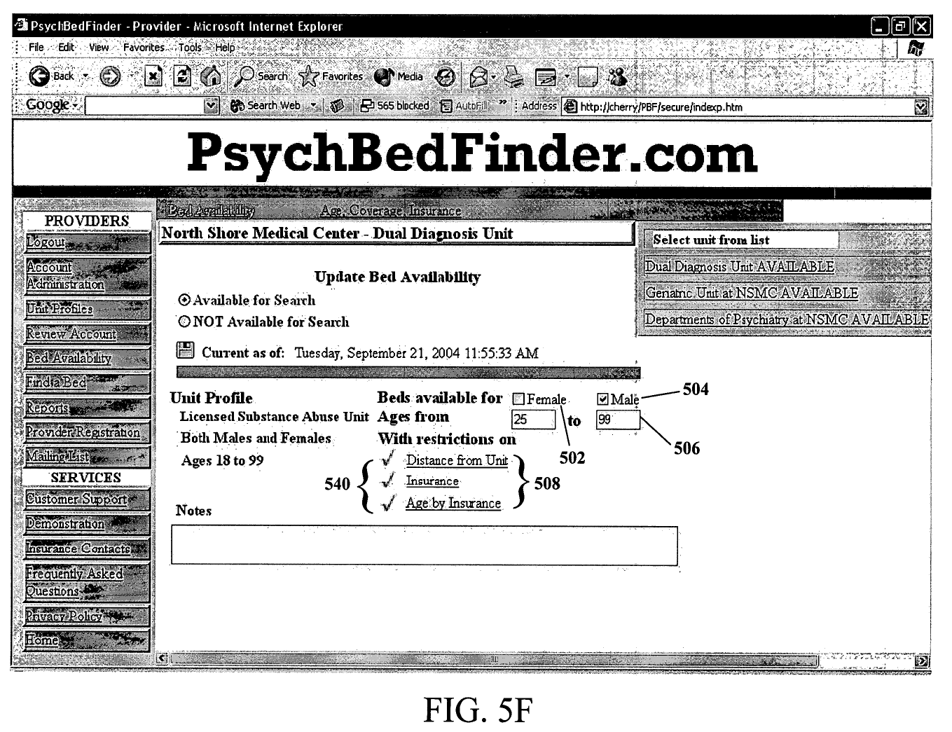

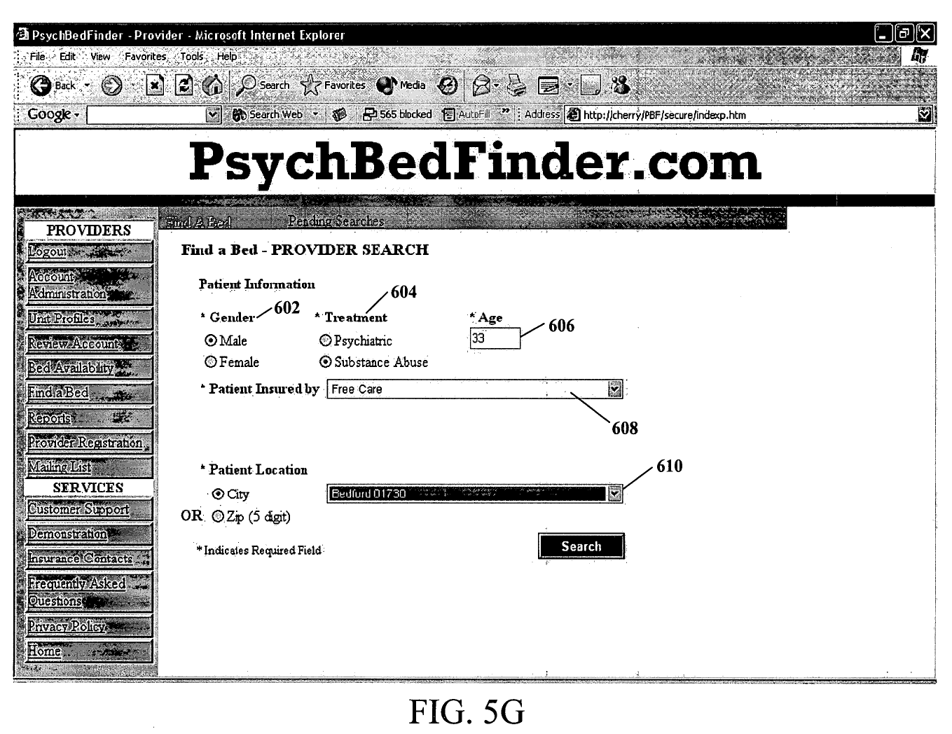

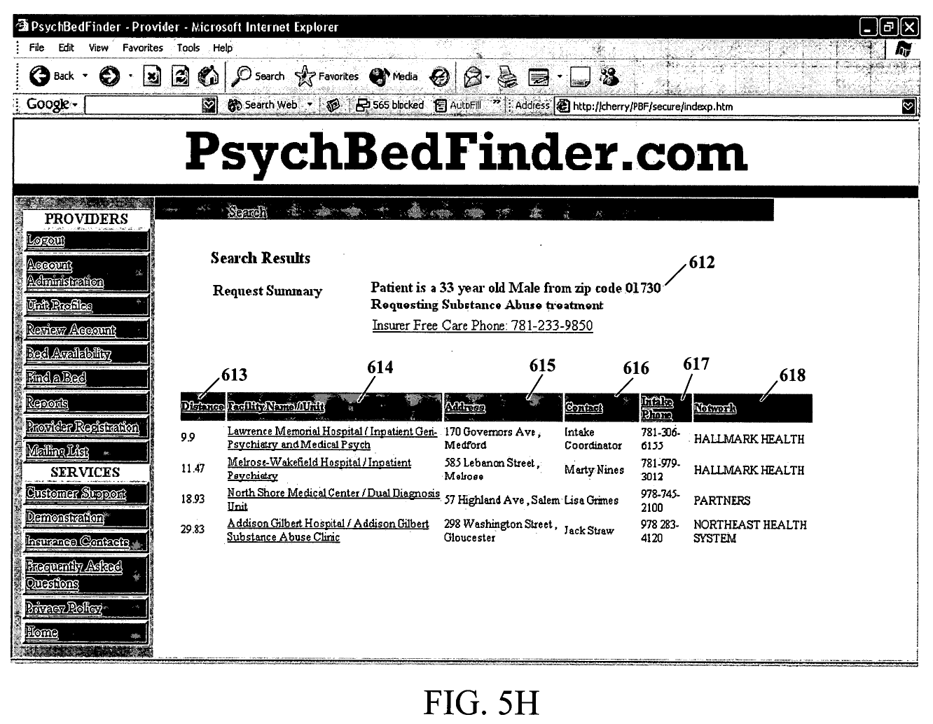

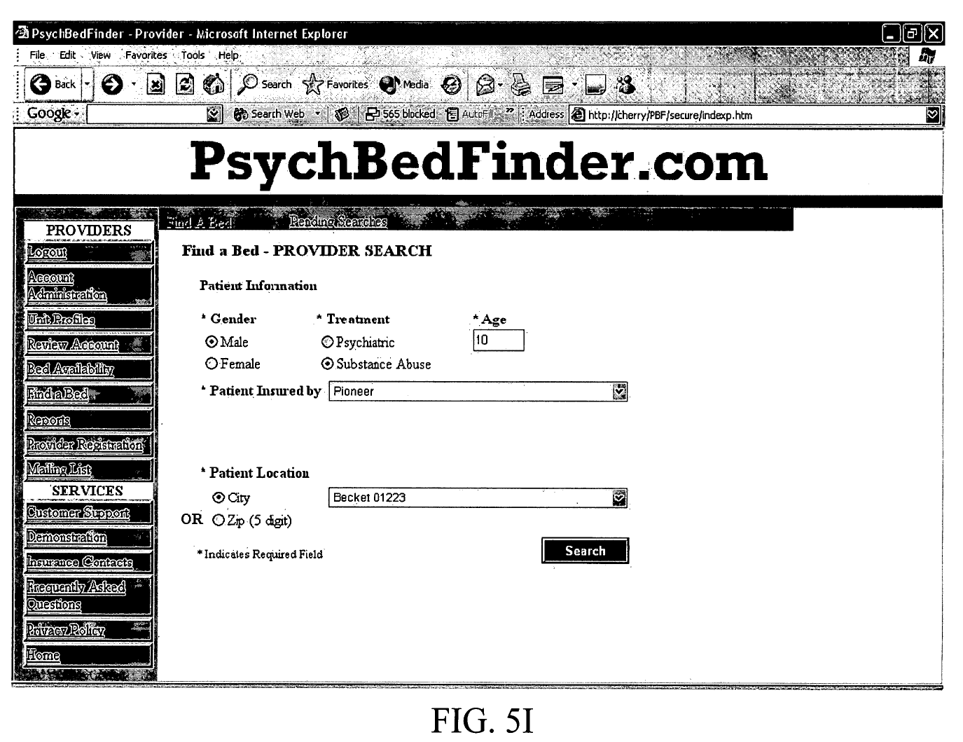

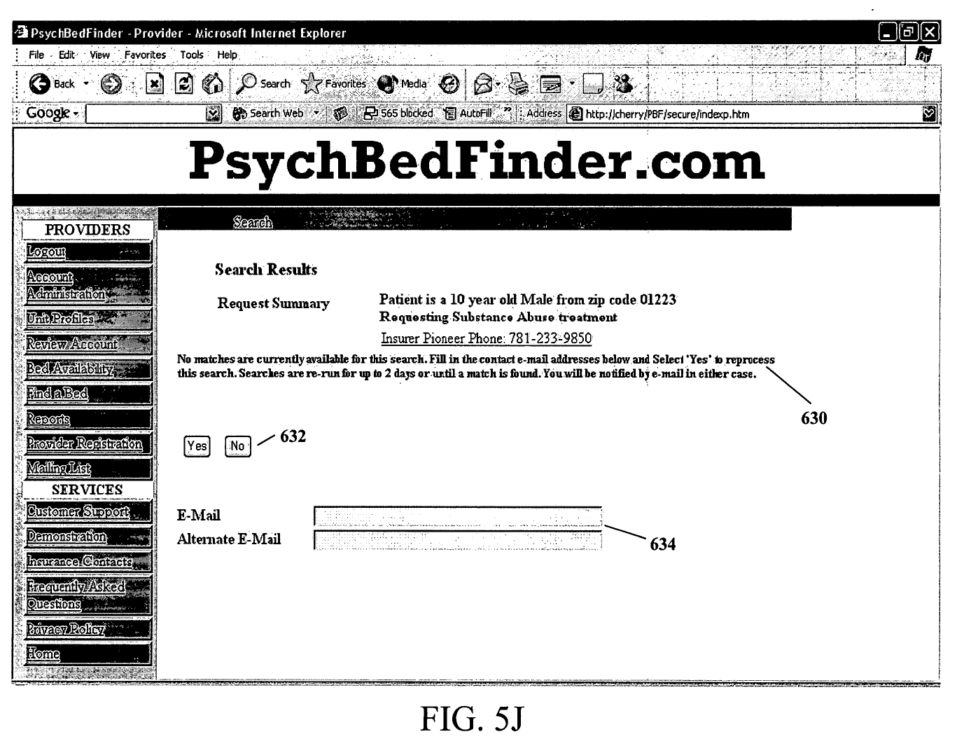

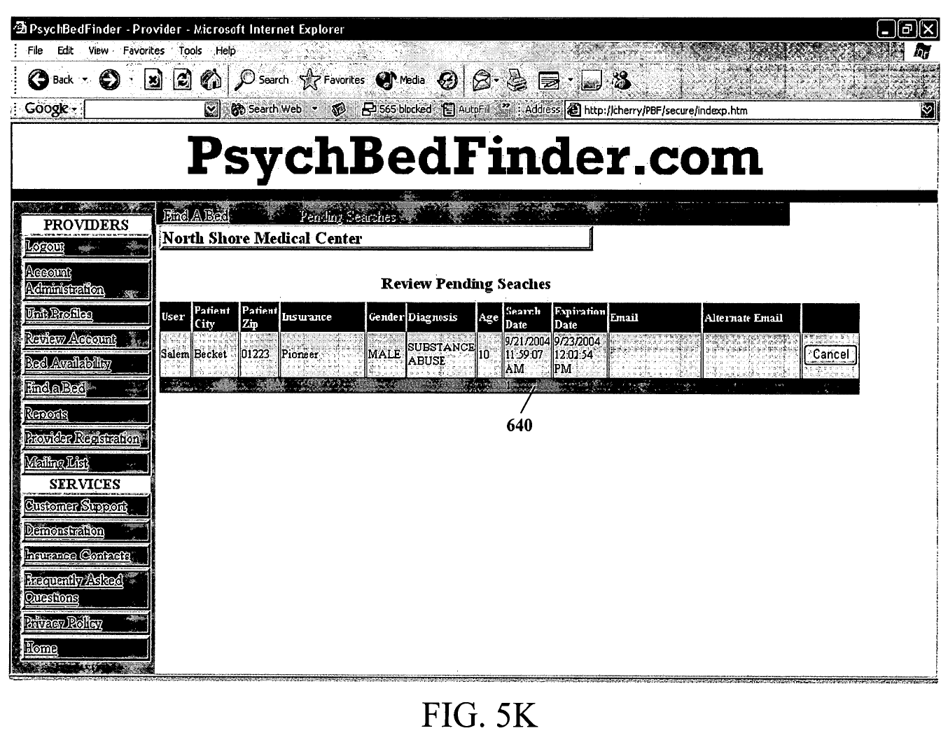

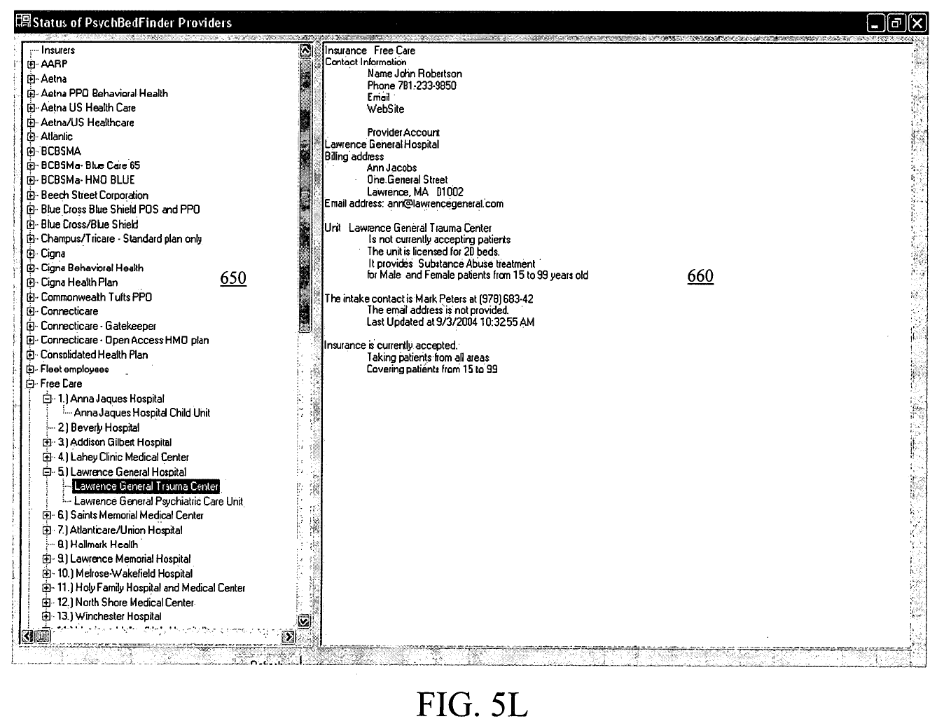

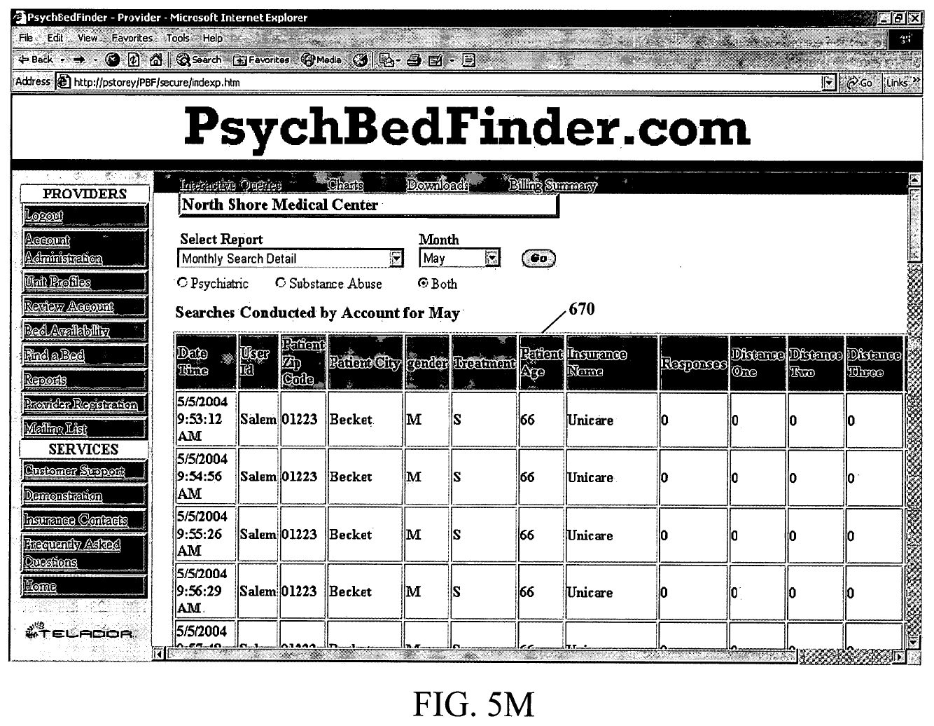

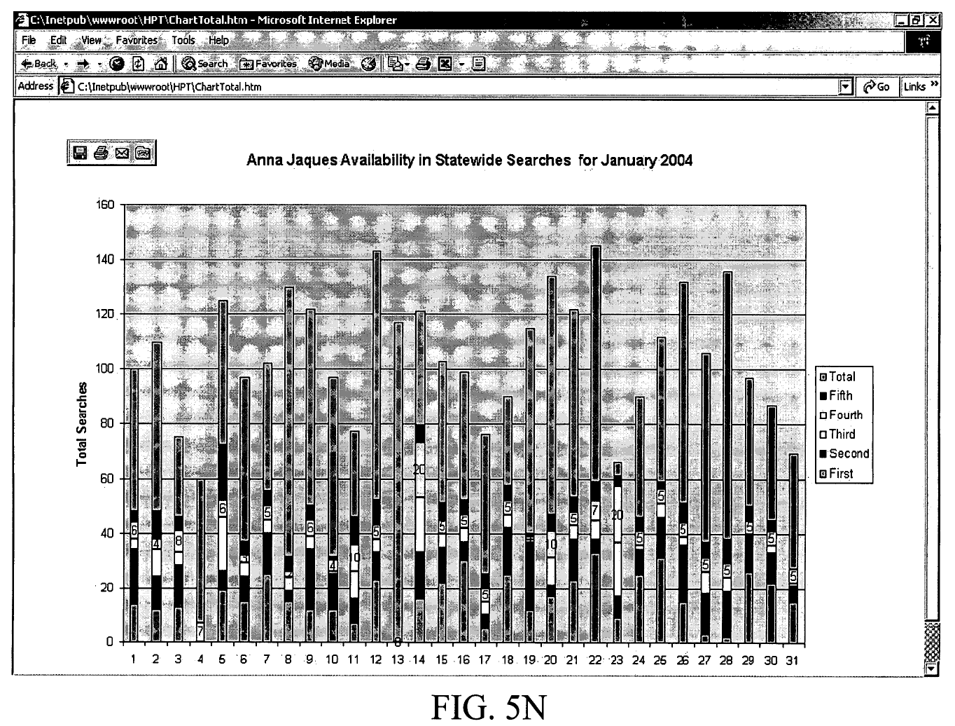

FIGS. 5A-5F depict an exemplary user interface that is provided by the web site to a provider that permits updating profile information. The screen shot of FIG. 5A provides an update screen that reveals the current description of what types of beds are available at the provider. When the provider reaches this screen, the various information in their profile may be changed in order to update the provider's profile. The user interface includes a variety of options such a selection links 501 on the left-hand side to control what is displayed on the user interface screen. If “Bed Availability” is selected, then a screen is displayed with information about the criteria of beds that the provider has available. For example, selection boxes 502, 504 allow a provider to select the gender of the patients for which beds are available. Similarly, text entry boxes 506 allow the provider to indicate the range of ages for what patients it is able to accept. There may be other restrictions 508 that the provider will need to specify as well. For example, a provider may not be covered by certain insurers, or the insurance coverage is limited by age or by distance. FIG. 5A also shows that a single provider may have a variety of different treatment units 510. Thus, the interface screen of FIG. 5A allows a provider to select one unit 509 from among different units 510 and set the profile for that unit 509 separately from the other units.

In FIG. 5B, for example, a provider has deselected the “Female” box 502 and leaves the “Male” box selected. To make the change to the profile, the provider then selects the radio button 512 that indicates that the selection criteria on the screen is not available for searching. As a result, in this example, the provider has indicated that male beds are not available even though the static profile for this provider indicates that the provider has male beds in its facility. By selecting the icon 514, the changes to the searchable profile for the provider can be saved at the web site. Thus, the changes are immediately available to affect the searches that are subsequently performed by different subscribers for available beds.

Returning to FIG. 5C, the provider may select one of the other restrictions 508 to change. For example, the “Insurance” link may be selected to result in the user interface providing the screen of FIG. 5D. This screen includes a column of Insurers 520, the minimum age insured 522, the maximum age insured 524, the distance for which they provide insurance 536, and whether or not the provider accepts this insurer 528. An “edit” feature 530 permits the provider to update this information. For example, a drop down box 532 allows the distance to be specified, while radio buttons 534 allow the selection of whether or not that insurer is accepted. To discard or accept the proposed changes, the provider selects an appropriate link 536 within the user interface. FIG. 5E depicts an exemplary edited screen based on provider input via the user interface. Thus, the provider can modify its static profile to reflect timely information about what beds are available or unavailable based on various insurance-related criteria. In some instances, the provider may use this information to allow (or avoid) its facilities to be included in searches involving uninsured patients. As a visual indication to the provider that certain other restrictions have been specified during the updating process, checkmarks 540, or other similar indicators, are provided nearby the restrictions 508.

In a preferred embodiment, the updated profile is a persistent data structure such that when a provider returns to the web site to perform additional updates, any previous updated information is already implemented in the different user interface screens presented to the provider.

Based on the searchable profile that exists on the web site, a provider will eventually be identified as having an available bed for a searching subscriber. Therefore, (returning to FIG. 2) the provider, in step 206, will receive an inquiry for a bed from a subscriber. The provider and subscriber can then allocate the bed to a patient according to their conventional methods of providing services.

In step 208, the provider retrieves statistics from the web site regarding the searches that were performed by various subscribers. Because the web site advantageously stores information about searches and search results, a variety of statistics are available for review by a provider. For example, a provider may determine how many searches are performed each day, what the criteria for those searches were, and how many searches identified the provider as the first choice for the subscriber (the second choice, the third choice, etc.) An exemplary, visual display of such information is depicted in FIG. 5N. The bar graph of FIG. 5N is merely exemplary in nature and such information can be provided in table format, various searchable database formats, or sorted and formatted according to different criteria specified by the provider.

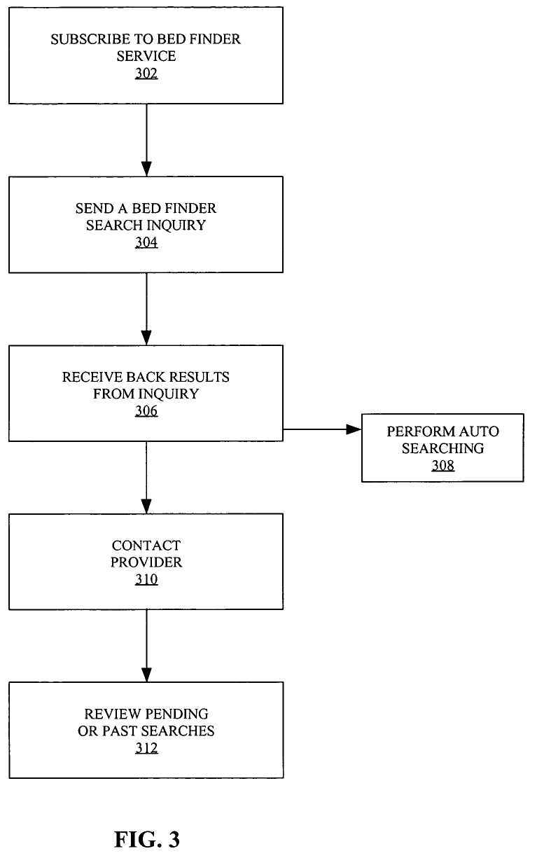

The flowchart of FIG. 3 depicts embodiments of the present invention from the perspective of a subscriber. Initially, in step 302, a subscriber agrees to use the web site to locate available beds. The contractual agreement between the subscriber and the web site can specify a variety of stipulations and requirements. However, once the agreement is in place, a subscriber is able to search the web site, in step 304, to locate available beds. FIG. 5G depicts an exemplary user interface screen through which a subscriber may search the web site. For each particular patient, the subscriber specifies the gender 602, the type of treatment 604, the age 606 and the insurance 608. While the location of the subscriber may be relevant to the search, embodiments of the present invention advantageously permit the subscriber to identify the residential location 610 of the patient. In this manner, the web site will locate a provider that is most conveniently located for the patient.

In step 306, the web site returns to the subscriber the results of the search. The user interface screen of FIG. 5H depicts one exemplary arrangement for presenting search results to a subscriber. A summary 612 of the patient is provided along with a series of columns describing the different providers having available beds. The left-most column 613 identifies the distance from the provider to the patient's home, column 614 identifies the name of the provider facility, and column 615 identifies the address of the provider's facility. Other information that may be displayed includes a contact name 616, a phone number 617, and an identification of a managed network 618 that the provider may belong to. The web site may select the provider information to display a) for all providers matching the search criteria, b) for the closest five (or some other number) providers, or c) for all matching providers within x miles of the patient.

If no providers having available beds are located, an optional auto search routine 308 may execute that repeats the search periodically throughout the day until a match is found. FIG. 5I depicts a second search for an available bed that relates to a 10 year old male in Becket. As seen in FIG. 5J, a message 630 is provided alerting the subscriber that no beds are currently available. The subscriber is then presented with section buttons 632 to specify whether or not the auto searching should be executed. If so, then a text entry box 634 is provided for the subscriber to enter an e-mail address to receive results of the search once it is successful.

Returning to FIG. 3, once the subscriber receives the search results, then the subscriber contacts, in step 310, a provider from the list. The parties can then provide services to the patient according to their conventional methods and practices.

In many instances, a subscriber will find it beneficial to review any pending auto-searches as well as review the searches they have historically performed. Accordingly, in step 312, the subscriber may login to the web site and retrieve historical information. An exemplary user interface screen is depicted in FIG. 5K that shows a tabular summary 640 of pending searches. FIG. 5M depicts a tabular representation 670 of the searches historically conducted by the subscriber. Such historical information may alternatively be provided in a format that sorts and formats the data according to the search criteria, the provider results, insurer name, etc. Another screen that may be beneficial to both providers and subscribers is depicted in FIG. 5L. From this screen, a user of the web site may locate information about different providers or verify the information which is being reported by the web site. As known to one of ordinary skill, the dual window environment of FIG. 5L includes a hierarchical list 650 that permits a user to drill-down to a selection and a detail window 660 that provides specific information about that selected entity.

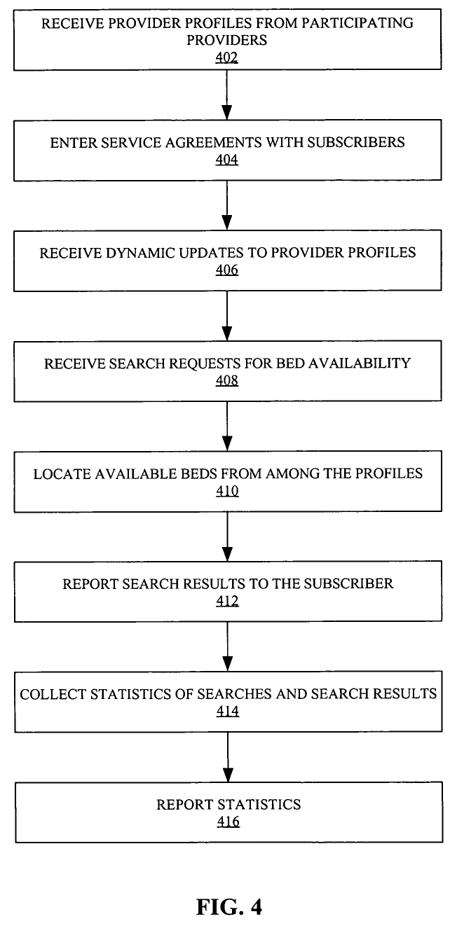

FIG. 4 depicts a flowchart of the operation of embodiments of the present invention from the perspective of the web site. As many of these functions have already been described in detail, they are only briefly described below. In step 402, the web site receives static profiles from the different providers that have beds potentially available. In order to make the web site economically viable, the providers pay a fee to the web site to be included in the search database. This fee may have a flat rate component and some variable rate component that is based on a variety of criteria. One such criteria would be the bed capacity of the provider.

Similarly, the web site, in step 404, enters service agreements with different subscribers. As a result, the subscriber is permitted access to the web site and can search for available beds. The fee arrangements for subscribers may, for example, be based on a per-search basis, a block of x searches at varying rates, or a flat fee per month. While in operation, the web site will periodically receive, in step 406, updates to the profiles for different providers. As these updates are stored in the system, the providers are able to control in real-time the status of their bed availability and, to a fine detail, the criteria of the beds that they have available. In step 408, the web site receives a search request from a subscriber and then locates, in step 410, available beds matching the search request within a certain geographic proximity to the patient. These search results are then reported to the subscriber, in step 412. In addition to reporting the search results, the web site also collects, in step 414, statistics about the search criteria and the results of the searches. When requested, the web site is then able to report those statistics, in step 416, to a subscriber or provider.

According to one embodiment of the present invention, the web site may also act as a clearinghouse for subscribers or providers who do not have reliable access to the Internet. According to this embodiment, the subscriber or provider may fax search criteria or bed availability information to the web site who enters the data and returns any results when appropriate.

### Conclusion

A system and method has been shown in the above embodiments for the effective implementation of an available inpatient psyciatric bed locator and community resource need tracker. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, and specific user-selected criteria. In particular, the embodiments of the present invention have specifically referred to implementation over the Internet. One of ordinary skill would readily appreciate that for greater security, or for other purposes, the network connection between the various entities could be provided through dedicated circuitry, a virtual private network, or other functionally equivalent facilities without departing from the scope of the present invention.

As described, the present system, unlike prior art systems, does not require the provider to reveal to subscribers or other parties when there are open beds or how many open beds there are. If the subscriber does not receive the name of a particular provider as a result of a search, the subscriber will not know any specific information about why that provider was not selected. Additionally, personnel at a provider will not be distracted with numerous phone calls asking about bed availability unless the web site has already identified them as having a matching bed available. With the historical data available from the web site, providers can determine patient usage statistics, subscriber search statistics, and criteria which prevented the subscriber from being identified as having available beds.

The above enhancements for icons and its described functional elements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of web-based and/or database programming.

1. A method for locating a patient bed at another facility, the method comprising the steps of:
storing a respective profile for a plurality of facilities, each profile including criteria related to an available bed at that facility;
receiving a search request to locate an available patient bed, the search request including a location of the patient;
searching the respective profiles based on the search request; and
displaying an identification of matching facilities, if any, from among the plurality of facilities, that are within a predetermined distance of the location of the patient.

2. The method of claim 1, wherein the search request includes search criteria about the patient.

3. The method of claim 2, further comprising the step of:
identifying the matching facilities by comparing the criteria related to the available patient bed with the search criteria about the patient.

4. The method of claim 1, wherein the criteria related to the available patient bed includes at least gender and age.

5. The method of claim 4, wherein the criteria related to the available patient bed includes insurer information.

6. The method of claim 5, wherein insurer information includes at least one of insurer name, insurer restrictions based on age, and insurer restrictions based on distance.

7. The method of claim 4, wherein the criteria related to the available patient bed includes diagnosis information for the patient.

8. The method of claim 4, wherein the criteria related to the available bed includes treatment specialties available at the respective facility.

9. The method of claim 1, further comprising the step of:
ranking the matching facilities based on their respective proximity to the location of the patient.

10. The method of claim 9, wherein the location of the patient includes a home residence of the patient.

11. The method of claim 1, further comprising the steps of:
receiving an update from a particular facility regarding a change in patient bed availability; and
updating the respective profile for that particular facility based on the received update.

12. The method of claim 11, wherein the update includes updated criteria related to available patient beds at that particular facility.

13. The method of claim 12, further comprising the steps of:
receiving a subsequent search request to locate another available patient bed; and
using the updated criteria when performing the step of searching the respective profiles.

14. The method of claim 1, further comprising the steps of:
determining that no matching facilities are identified; and
automatically repeating the search request until a matching facility having an available patient bed is identified.

15. A method for facilitating identification of available patient beds, comprising the steps of:
providing storage for a respective profile for each of a plurality of inpatient facilities, wherein each respective profile includes criteria related to an available patient bed at that inpatient facility;
permitting a healthcare organization to search the respective profiles to locate, for a patient, an available patient bed matching a specified set of criteria; and
returning to the healthcare organization an identification of matching facilities, if any, that are within a predetermined distance of the patient.

16. The method of claim 15, further comprising the step of:
generating revenue from each of the inpatient facilities by charging a fee based on respective patient capacity of each facility.

17. The method of claim 15, further comprising the step of:
generating revenue from the healthcare organization by charging a fee for searching the respective profiles.

18. The method of claim 15, wherein the criteria related to the available patient bed includes at least gender and age.

19. The method of claim 18, wherein the criteria related to the available patient bed includes insurer information.

20. The method of claim 18, wherein the criteria related to the available patient bed includes diagnosis information.

21. The method of claim 15, further comprising the steps of:
presenting to a particular inpatient facility an interface to update their respective profile; and
receiving an update from that particular inpatient facility; and
performing subsequent searches of that particular inpatient facility based on the received update.

22. The method of claim 15, wherein the step of returning, further includes the step of:
ranking the matching facilities based on proximity to a home residence of the patient.

23. An apparatus comprising:
at least one microprocessor;
a memory in communication with the at least one microprocessor;
a program code stored in said memory and when executed by said microprocessor, configured to:
store a respective profile for a plurality of facilities, each profile including criteria related to an available patient bed at that facility;
receive a search request to locate an available patient bed, the search request including a location of a patient;
search the respective profiles based on the search request; and
display an identification of matching facilities, if any, from among the plurality of facilities, that are within a predetermined distance of the location of the patient.

24. The apparatus of claim 23, wherein the search request includes search criteria about the patient.

25. The apparatus of claim 24, wherein the program code when executed is further configured to:
identify the matching facilities by comparing the criteria related to the available patient bed with the search criteria about the patient.

26. The apparatus of claim 23, wherein the criteria related to the available patient bed includes at least gender and age.

27. The apparatus of claim 26, wherein the criteria related to the available patient bed includes insurer information.

28. The apparatus of claim 26, wherein the criteria related to the available patient bed includes diagnosis information for the patient.

29. The apparatus of claim 26, wherein the criteria related to the available patient bed includes treatment specialties available at the respective facility.

30. The apparatus of claim 23, wherein the program code when executed is further configured to:
rank the matching facilities based on their respective proximity to the location of the patient.

31. The apparatus of claim 30, wherein the location of the patient includes a home residence of the patient.

32. The apparatus of claim 23, wherein the at least one microprocessor, memory, and program code are part of a web site available through an Internet.
